(19) United States
(12) Patent Application Publication
(10) Pub. No.: US 2026/0242014 A1
(43) Pub. Date: Aug. 20, 2026

(54) KINGPIN ASSEMBLY

(71) Applicant: Jost - Werke Deutschland GmbH, Neu-Isenburg (DE)

(72) Inventors: José Manuel ALGÜERA GALLEGO, Aschaffenburg (DE); Swen SAUPE, Mainz (DE)

(21) Appl. No.: 19/164,868

(22) PCT Filed: Mar. 25, 2024
(86) PCT No.: PCT/EP2024/057916

§ 371 Date: Sep. 12, 2025

(30) Foreign Application Priority Data
Mar. 28, 2023 (DE) 10 2023 107 894.1

(51) Int. Cl. B62D 53/08; B60D 1/64; G01D 5/14

(52) U.S. Cl. CPC B62D 53/0842; B60D 1/64; G01D 5/14

(57) ABSTRACT

The invention relates to a kingpin assembly (1) for a semi-trailer of an articulated vehicle, comprising a kingpin (2) defining an axis of rotation (A), wherein the kingpin (2) has a kingpin flange (3) for connecting the kingpin (2) directly or indirectly to the semi-trailer. It further comprises an angle measuring device (15) at least partially recessed into the kingpin (2) with a shaft (17) rotatably mounted about the axis of rotation (A) and a driver (18) connected to the shaft (17) and pivotable about the axis of rotation (A).

### CROSS-REFERENCE TO RELATED APPLICATIONS

This application is the U.S. national stage application of International Patent Application No. PCT/EP 2024/057916, filed Mar. 25, 2024, which claims the benefit under 35 U.S.C. § 119 of German Application No. 10 2023 107 894.1, filed Mar. 28, 2023, the disclosures of each of which are incorporated herein by reference in their entirety.

### FIELD OF THE INVENTION

The invention relates to a kingpin assembly for a semi-trailer of an articulated vehicle, comprising a kingpin defining an axis of rotation, wherein the kingpin has a kingpin flange for connecting the kingpin directly or indirectly to the semi-trailer.

### BACKGROUND

Such a kingpin assembly is known, for example, from the publications DE 20 2022 106 659 U, EP 3 891 051 A1, EP 1 918 179 A1, and DE10 2004 024 333 A1.

The tractor vehicle and the semi-trailer, also simply referred to as a trailer, form the articulated vehicle, also known as a tractor-semi-trailer combination. A fifth wheel coupling plate is arranged on the tractor vehicle, with which the kingpin located on the bottom side of the semi-trailer is engaged and locked. For coupling the semi-trailer, the fifth wheel coupling plate is usually designed with a wedge-shaped entry opening tapering in the direction of travel, whereby the entry opening has a free installation space with a depth that ensures that the kingpin can enter and exit the fifth wheel coupling plate without obstruction. During coupling, the semi-trailer slides with its semi-trailer plate, on which the kingpin is mounted in a fixed position either directly or indirectly, on the surface of the fifth wheel coupling plate, thereby determining its vertical position. Lateral guidance is ensured by the kingpin, which is positively guided in the entry opening during coupling until it reaches its locking position. The lower boundary of the entry opening is determined by the length of the kingpin. Components located below the entry opening, such as reinforcement ribs, cannot therefore be contacted by the kingpin when the semi-trailer is being coupled or uncoupled.

Unless explicitly stated otherwise, terms such as “vertical,” “horizontal,” “top,” and “bottom” refer to the direction of gravity. Accordingly, the “bottom side” is the side (e.g., of the kingpin) facing downwards in relation to the direction of gravity, and the “top side” is the side facing upwards in relation to the direction of gravity. Unless explicitly stated otherwise, terms such as “axial,” “radial,” and “tangential” refer to the axis of rotation defined by the kingpin.

When the tractor vehicle and semi-trailer are coupled, it is desirable to know the angular position of the semi-trailer relative to the tractor vehicle as accurately as possible and to communicate this to a control device on the tractor vehicle and/or semi-trailer. This information is relevant, for example, for steerable axles on the semi-trailer or for optimizing driver assistance systems, both when reversing and driving forward. There are numerous approaches to determining the so-called articulation angle between the tractor vehicle and the semi-trailer. Reference is made, for example, to documents CN 1 12 298 383 A, EP 3 162 665 A1, EP 3 210 857 B1, DE 20 2012 008 717 U1, DE 199 64 059 A1, US 5 152 544 A, WO 2020/248 035 A1, US 2013/082 453 A1, US 2015/084 311 A1, GB 2 470 610 A, DE 10 2018 123 642 A1. Most known systems use a magnet and a magnetic field sensor. The sensor is usually attached directly or indirectly to the fifth wheel coupling plate and the magnet to the kingpin. A disadvantage of this arrangement is that the measurement result depends not only on the articulation angle, but also on a misalignment between the sensor and the magnet after coupling and on play between the kingpin and the fifth wheel coupling plate when coupled, and these two influencing factors therefore result in the output of incorrect angle values.

### SUMMARY OF THE INVENTION

The subject invention provides a kingpin assembly that creates the conditions for simple and accurate determination of the articulation angle.

According to embodiments of the invention, the kingpin assembly has an angle measuring device that is at least partially recessed into the kingpin, with a shaft that can rotate around the axis of rotation and a driver that is rotationally fixed to the shaft so it can rotate and pivot around the axis of rotation (A).

In contrast to an angle sensor with an external angle encoder, an angle measuring device is understood to be a unit integrated in a housing and consisting of an angle encoder and an angle sensor matched to it and rotatable relative to the angle encoder about the axis of rotation, wherein, for the purpose of transmitting a rotary movement, the shaft is connected in a rotationally fixed manner to either the angle encoder or the angle sensor and is rotatably mounted in the housing. The counterpart of the unit, i.e. the angle sensor or the angle encoder, is in turn connected to the housing in a rotationally fixed manner so that either the shaft together with the angle encoder can rotate relative to the angle sensor and the housing or, conversely, the shaft together with the angle sensor can rotate relative to the angle encoder and the housing. Consequently, the driver drives the angle encoder or the angle sensor via the shaft and the counterpart is held connected to the kingpin in a rotationally fixed manner via the housing.

This inventive solution differs from all known solutions in that both the angle sensor and the angle encoder are assigned to the kingpin assembly and thus to the semi-trailer. The relative position of the angle sensor and angle encoder is therefore always the same, apart from the articulation angle to be detected, regardless of the condition of the fifth wheel coupling plate and its spatial position relative to the kingpin after the tractor vehicle has been coupled to the semi-trailer. The solution according to the invention also has the considerable advantage that it can be retrofitted very easily, since only the semi-trailer needs to be modified.

A driver is understood here to be a means which is connected on one side to the shaft of the angle measuring device in rotationally fixed manner and is designed on the other side to be supported directly or indirectly on a component of the tractor vehicle, such as the fifth wheel coupling plate, its bearing blocks, its support frame or a connecting unit (plug socket) or its support, thereby transmitting a relative rotation of this component about the axis of rotation to the shaft. The driver is designed, for example, to interact with the fifth wheel coupling plate in the coupled state in such a way that the relative rotation between the kingpin and the fifth wheel coupling plate is transmitted to the shaft with as little play as possible. For this purpose, indirect or direct positive contact between the driver and the fifth wheel coupling plate or an element fixed to it may be considered.

The driver preferably comprises a centering element which is designed to center the driver in relation to the entry opening of a fifth wheel coupling plate of a tractor vehicle.

In this design, the centering element therefore serves to support itself on the fifth wheel coupling plate and thereby transmit a relative rotation thereof about the axis of rotation of the kingpin to the shaft.

The shaft is preferably led out on a bottom side of the kingpin facing away from the kingpin flange and connected to the driver.

The shaft is referred to as “led out” if it protrudes from the bottom side of the housing of the angle measuring device and/or the kingpin in such a way that radial access to the shaft is possible, for example to connect the driver radially to the shaft.

Preferably, the kingpin protrudes on the bottom side with at least one projection in the axial direction downwards beyond the driver and the shaft.

The projection serves to protect the shaft and the driver, in particular when the kingpin is moved into and out of the entry opening of the fifth wheel coupling plate, against collision with components of the tractor vehicle, in particular the fifth wheel coupling plate, its bearing blocks or substructure.

The angle measuring device is advantageously a non-contact angle measuring device. This preferably has a non-contact angle sensor, in particular a magnetic field or Hall sensor, a capacitive sensor or an optical sensor.

Contactless sensor technology has a number of advantages, in particular it is not susceptible to wear, has virtually no slip, and an electronic signal is obtained immediately, which can be made available for further processing.

The angle encoder can therefore be advantageously designed to generate a magnetization pattern, in particular it can comprise one or more magnets or magnetic sections or magnetic coatings, an optically detectable marking pattern, in particular a color application or a color change.

The angle sensor preferably comprises or generates a pattern that varies in the circumferential and/or radial direction.

The variation enables the evaluation electronics to assign the sensor signal to an angular position even when there is no relative movement between the angle sensor and the angle encoder, i.e. when the kingpin is not rotating relative to the fifth wheel coupling plate.

The pattern preferably defines a center position.

According to a particularly advantageous further development, the angle measuring device comprises a magnetic angle sensor and an angle encoder that generates a magnetization pattern.

As an alternative to a contactless angle measuring device, a potentiometric angle measuring device may also be provided.

The kingpin assembly preferably has a weld-in plate connected or connectable to the semi-trailer, which is designed for connection to the kingpin flange.

The weld-in plate is a known plate-shaped attachment part which is usually welded to the semi-trailer plate of the semi-trailer and has a mounting surface matching the kingpin flange with mounting holes for fastening the kingpin. The weld-in plate allows nondestructive removal and replacement of the kingpin.

In a first alternative embodiment, the angle measuring device is preferably recessed into the kingpin on the upper side attributed to the kingpin flange, and the shaft is rotatably mounted or received in a bore that axially penetrates the kingpin.

This embodiment has the advantage that the angle measuring device is enclosed between the king pin and the weld-in plate and is therefore very well protected against mechanical damage. Damage to the device during coupling is virtually impossible. Furthermore, the shaft is guided over a greater length in the king pin so that any radially acting loads are not or only to a small extent transmitted to the bearing of the shaft in the angle measuring device.

It is particularly preferred that the angle measuring device is recessed into the king pin on the upper side to such an extent that the angle measuring device has a distance d>1 mm, preferably >2 mm, to the bottom of the weld-in plate when the kingpin is connected to the weld-in plate, and it is particularly preferred that the angle measuring device is recessed flush with the upper side in the kingpin.

This ensures that the angle measuring device fits completely into the installation space between the kingpin and the weld-in plate and is protected from damage before and during installation.

In a second alternative embodiment, the angle measuring device is preferably recessed into the kingpin on the bottom side facing away from the kingpin flange.

This embodiment has the advantage that the hole penetrating the kingpin axially can be dispensed with. Furthermore, the angle measuring device is easily accessible from the outside on this side, so that the kingpin does not have to be removed first for replacement or repair. Finally, the cable routing to the angle measuring device is also simplified.

Preferably, the kingpin assembly has a pivot bearing arranged around the axis of rotation, which has a bearing ring stationary relative to the kingpin or a stationary bearing ring segment and a bearing ring rotatable relative thereto or a rotatable bearing ring segment, wherein the driver is fixed in a rotationally fixed manner directly or indirectly to the rotatable bearing ring or rotatable bearing ring segment.

Such a rotary bearing is already known, for example, from the aforementioned publications DE 20 2022 106 659 U, EP 3 891 051 A1, EP 1 918 179 A1, and DE10 2004 024 333 A1. The subject invention provides for using this rotary bearing to guide the driver, which is otherwise only connected to the shaft of the angle measuring device, thereby relieving the bearing of the shaft in the housing of the angle measuring device when radial loads occur and ensuring a defined rotational movement of the angle sensor and angle encoder relative to each other. “Indirectly or directly fixed” to the rotatable bearing ring or rotatable bearing ring segment means that the driver, where required, is also connected to the bearing ring or rotatable bearing ring segment via other components and, apart from normal elasticity, without any degrees of freedom of movement.

The rotary bearing is preferably arranged at a radial distance from the kingpin. The driver is therefore preferably supported at a radial distance from the shaft and, in particular, at its free end on the rotatable bearing ring or the rotatable bearing ring segment.

It should be noted that both stationary bearing rings and rotatable bearing rings with a 360° circumference as well as only “bearing ring segments” or a combination of a bearing ring on the one hand and a “bearing ring segment” on the other hand can be used for the rotary bearing. Bearing ring segments are generally sufficient to ensure the degree of freedom of the rotary movement and to fix the position in all other dimensions, especially since the fifth wheel coupling only allows a rotary movement over a partial circle of max. approx. 260° anyway. However, completely ring-shaped stationary and rotatable bearing rings have the advantage of greater rigidity, which in turn ensures more precise position definition, especially when tilting moments occur, and are therefore generally preferable.

Preferably, the kingpin assembly also has a support frame fixed to the rotatable bearing ring or rotatable bearing ring segment, wherein the driver is fixed to the support frame and thus indirectly to the rotatable bearing ring or rotatable bearing ring segment.

The support frame is preferably further configured to accommodate a connecting means for connection to a corresponding connecting unit of a tractor vehicle, in particular an electrical and/or electromagnetic and/or pneumatic and/or hydraulic connecting means.

The electrical and/or electromagnetic and/or pneumatic and/or hydraulic connecting device is part of a plug-in coupling system for connecting lines between the tractor vehicle and the semi-trailer, as described, for example, in DE 10 2004 024 333A 1 . Plug-in coupling systems are known in various designs. The plug-in coupling system contains at least a plug and a socket and, as a rule, also other components which serve to automatically connect and disconnect the plug and socket when coupling and uncoupling the semi-trailer and the tractor vehicle. In this sense, the term “connecting means” therefore comprises at least a plug or a socket. For safety reasons, the current-carrying end of the plug coupling system is usually designed as a socket on the tractor vehicle, while the corresponding plug is located on the semi-trailer. In particular, the socket is fixed to the fifth wheel coupling below the entry opening and is therefore located in a protected area where it cannot collide with the kingpin during entry. The connecting device, usually the plug, is typically located on the bottom side of the support frame or inside the support frame in a cavity.

Furthermore, the plug can be arranged on a base plate on the support frame, which is mounted in a vertically spring-loaded manner relative to the support frame. When the semi-trailer is coupled until the plug and socket are finally connected, the spring-loaded base plate or the plug is guided under pressure against an insertion aid in the area of the entry opening, whereby positioning also takes place automatically in the vertical direction, thus ensuring any necessary height compensation.

Viewed in projection onto a horizontal plane, the support frame preferably has a wedge- or V-shaped design which is at least in sections complementary to the wedge-shaped entry opening of the fifth wheel coupling plate. This ensures that the support frame aligns itself with the fifth wheel coupling during insertion, which on the one hand enables the plug and socket to be connected securely and on the other hand ensures that the driver fixed to the support frame is centered in relation to the insertion opening in the fifth wheel coupling plate by means of an indirect form fit. In other words, the support frame forms the centering element which centers the driver in relation to the entry opening of a fifth wheel coupling plate of a tractor vehicle.

The support frame preferably has a support element that is axially spaced from the rotatable bearing ring or the rotatable bearing ring segment and rests directly against the kingpin.

The rotatable bearing ring or the rotatable bearing ring segment, together with the stationary bearing ring or the stationary bearing ring segment, forms an axial-radial rotary bearing, i.e. an upper suspension for the support frame with only one degree of rotational freedom for the same. The position of the support frame is determined by the rotary bearing radially and axially relative to the kingpin and thus to the trailer plate. However, due to its radial length and an unfavorable lever at its free end on the plug side, the support frame can tilt downward, especially when wear occurs. This can only be partially counteracted by stiffening the bearing design and the support frame, especially since these components should be as lightweight as possible. For this reason, the support element is provided, which counteracts the tilt by forming a lower support for the support frame on the kingpin, axially spaced from the plane of the rotary bearing—this is defined by the plane of the sliding surfaces of the bearing rings/bearing ring segments lying on top of each other. The support element rests on the kingpin and, preferably, on the upper or lower collar of the kingpin, and transfers any tilting moments that occur to the kingpin. This defines the vertical position of the support frame and the plug relative to the kingpin and the trailer plate and ensures that the coupling process can be carried out safely in the manner described above by means of vertical and horizontal guidance.

It is also preferred that the support element is length-adjustable in the radial direction relative to the axis of rotation.

Due to wear, and in particular in the case of retrofitted or replaced kingpin assemblies, manufacturing tolerances may cause variations in the relative position of the connecting elements and the kingpin, which may compromise safe coupling despite the support described above. The support element, which is adjustable in length in the radial direction, provides an adjustment option for the inclination of the support frame. This allows fine adjustment of the vertical position of the plug relative to the socket, which can be used to compensate for manufacturing tolerances, wear, or similar factors, so that coupling can be carried out safely in the usual manner.

The support element preferably has a sliding surface that is in contact with the kingpin. Since the support element is a separate component, it can be easily optimized in terms of its function as a sliding element. This is particularly preferred by forming the sliding surface from a surface of a friction-reducing material. In this sense, the sliding element can be made predominantly from the friction-reducing material, in which case it would be referred to as a solid material, or it can have a coating made from such a material. A friction-reducing material refers to a material that contains tribologically effective fillers, known as dry lubricants, such as, preferably, graphite, PTFE, MoS₂, h-BN, lead, tin, or the like, and therefore has a low coefficient of friction in interaction with the kingpin compared to the aluminum or steel material without fillers that is normally used for the support frame. Plastics, bronze, or aluminum, for example, can be considered as matrix materials for such solid materials or coatings.

The support element therefore also preferably has a plastic matrix at least along the sliding surface, in particular made of thermoplastic, in particular polyethylene (PE), polyamide (PA), polypropylene (PP), polyetheretherketone (PEEK), polyetherimide (PEI), polyoxymethylene (POM), acrylonitrile-butadiene-styrene (ABS).

The kingpin preferably has a cylindrical surface with a radius r arranged coaxially around the axis of rotation, or at least a segment thereof, against which the support element rests. Here too, it should be noted that, due to the limited angle of rotation of the fifth wheel coupling, one cylinder segment is sufficient, but the kingpin generally has one, or, due to its mandatory constriction, several circular cross-sections and, in this sense, has at least one cylindrical surface against which the support element can bear. Since the mandatory constriction is intended for locking with the fifth wheel coupling, the kingpin can be supported either above it, on the so-called upper collar, or below it, on the so-called lower collar.

The sliding surface is preferably designed geometrically so that the support element is centered relative to the kingpin in a direction perpendicular to the axis of rotation. This is advantageously achieved either by the sliding surface forming a V-shaped contour in a plane perpendicular to the axis of rotation, or by the sliding surface being designed as a concave curved surface with a radius r′, wherein the radius r′ is between r−5 mm and r+5 mm, more preferably between r−1 mm and r+5 mm, and particularly preferably between r and r+5 mm. In both cases, the position of the sliding surface is defined in the tangential direction relative to the axis of rotation or the cylinder surface of the kingpin.

The support element is preferably connected to the support frame by means of a connecting element that is length-adjustable in the radial direction relative to the axis of rotation. The connecting element, as part of the support element, ensures its adjustability in the radial direction. In particular, the support element is connected to the support frame by means of a threaded rod (as a connecting element) extending in the radial direction relative to the axis of rotation. Alternative embodiments provide pins or rods in conjunction with clamping pieces or clamping screws, strips with elongated holes and connecting screws, a toggle lever arrangement or toothed or interlocking elements such as a rack and corresponding counterparts engaging in the toothing instead of the threaded rod.

The support frame preferably has a cross strut on which the length-adjustable connecting element and/or the threaded rod is supported. The cross strut extends in a plane perpendicular to the axis of rotation and essentially tangentially at a sufficient distance from the kingpin to allow the support element to be adjusted in length.

The stationary bearing ring or the stationary bearing ring segment is preferably attached directly to the kingpin flange. This allows the kingpin assembly to be easily replaced or retrofitted without having to make any structural changes to the semi-trailer itself. For example, an old kingpin can be unscrewed from the semi-trailer plate and a new kingpin with the same hole pattern can be mounted in its place in the kingpin flange together with the pivot bearing and support frame.

The stationary bearing ring or the stationary bearing ring segment is preferably located, referring to the axis of rotation, radially inside and the rotatable bearing ring or the rotatable bearing ring segment is located radially outside. This also contributes to easy replacement or retrofitting of the kingpin assembly while ensuring optimum rotational guidance, as will be explained below with reference to the drawings.

A spacer is preferably arranged on the support frame, protruding upward in the direction of the axis of rotation of the support frame, which is designed to support the support frame directly or indirectly on the semi-trailer.

The length-adjustable support element is preferably adjusted so that the support frame with the spacer rests against the trailer plate, thereby reducing the tendency of the support frame to vibrate and further precisely determining the position of the free end of the support frame at which the connecting means is arranged. In order to avoid mechanical tension when the support frame rotates around the kingpin, the support element is advantageously aligned with the lowest point of the area of the semi-trailer plate that can be covered by the support frame when rotating.

The rotatable bearing ring or the rotatable bearing ring segment advantageously has a cylinder wall segment extending in the direction of the axis of rotation, to which the support frame is fixed. The cylinder wall segment forms the vertical connection from the plane of the axial rotary bearing to the support frame and is also suitable for forming the cross strut for supporting the length-adjustable connecting element and/or the threaded rod.

The cylinder wall segment preferably has a width in the tangential direction of <(2.1×r) and is thus involved as the radially innermost part of the V-shaped support element in the guidance of the connecting means during coupling.

In a preferred embodiment, the support element is designed to be elastically deformable relative to the axis of rotation, at least in the radial direction, and/or has a spring element acting in this direction, so that the support element rests against the kingpin under an adjustable preload. The spring element can be, for example, a spiral compression spring, a disc spring pack, or an elastically deformable plastic body. This design, in conjunction with the length adjustment of the support element, allows a specific preload to be set, which always ensures that the support element bears against the kingpin and the support frame on the trailer plate with constant contact pressure. This reduces any tension in the support frame and at the same time dampens vibrations of the support frame even more effectively.

These and other features and advantages of the invention are explained in more detail below with reference to the figures.

### BRIEF DESCRIPTION OF THE DRAWINGS

FIG. 1 a partially sectioned side view of a first embodiment of the kingpin assembly;

FIG. 2 a sectional view of a third embodiment of the kingpin assembly;

FIG. 3 is a sectional view of a second embodiment of the kingpin assembly;

FIG. 4 the kingpin assembly viewed from below with support frame and

FIG. 5 the kingpin assembly in an exploded view.

### DETAILED DESCRIPTION

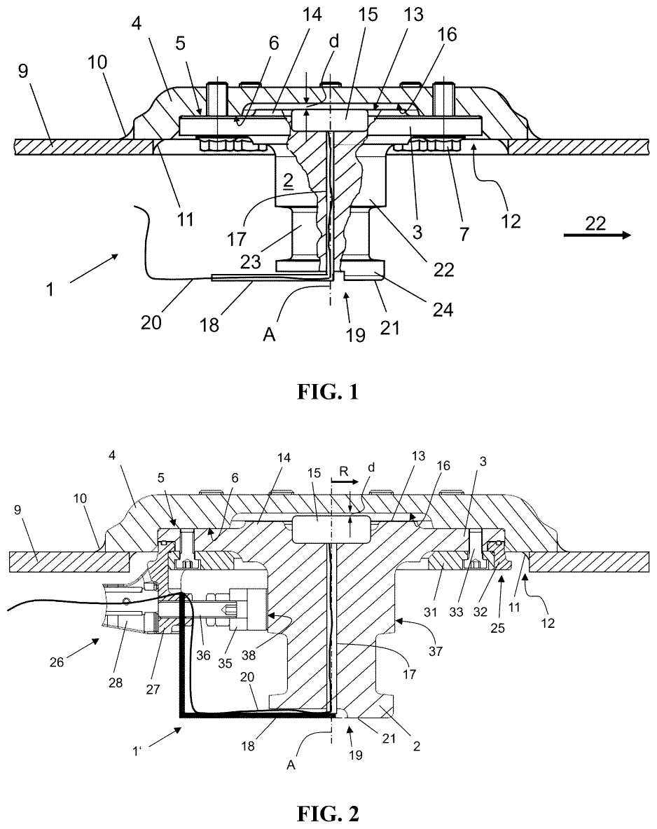

FIG. 1 shows a kingpin assembly 1 for a semi-trailer of a truck tractor with a kingpin 2 defining a pivot axis A. The kingpin 2 has a kingpin flange 3 for connecting the kingpin 2 to a weld-in plate 4. The kingpin flange rests with its usually face-turned mounting surface 5 on a likewise face-turned mounting surface 6 of the weld-in plate 4 and is fixed thereto by means of a plurality of screws 7 arranged circularly about the pivot axis A.

The weld-in plate 4 is in turn welded to a support plate 9 of the semi-trailer (not shown). The welded connection is symbolized by two circumferential weld seams 10 and 11. The first circumferential weld seam 10 is visible along the maximum circumference of the weld-in plate 4 and the second circumferential weld seam 11 is visible along the inner circumferential surface of a through hole 12 in the trailer plate 9, through which the kingpin 2 protrudes downwards into the free space under the trailer plate 9.

The kingpin 2 has a ring-shaped bead 14 around the axis of rotation A on its upper side 13 facing the flange 3. This is an artifact of the kingpin, which is usually forged. The bead 14 forms the highest elevation of the upper side 13 of the kingpin 2 in the installation position shown.

The king pin assembly 1 has an angle measuring device 15 which is at least partially recessed into the king pin 2 from above. More precisely, the angle measuring device 15 is flush with the upper side 13 of the kingpin 2, i.e. the bead 14, and has a distance d to the bottom 16 of the weld-in plate 4 facing the kingpin 2. This provides mechanical protection for the angle measuring device 15 before and during installation of the kingpin on the weld-in plate 4. Furthermore, it is ensured that the angle measuring device 15 fits completely into the installation space between the kingpin 2 and the weld-in plate 4 and that no costly modification of the weld-in plate 4, which is firmly connected to the semi-trailer, is necessary.

The angle measuring device 15 has a shaft 17 mounted so as to be rotatable about the axis of rotation A and a driver 18 connected to the shaft 17 and pivotable about the axis of rotation A.

The shaft 17 is mounted or received so as to be rotatable in a bore axially penetrating the kingpin 2. The shaft 17 is led out of the kingpin 2 on an bottom side 19 of the kingpin 2 facing away from the kingpin flange 3 and is connected there to the driver 18 in a rotationally fixed manner. The driver 18 extends in a radial direction away from the shaft 17 and connects the latter directly or indirectly to a component of the tractor vehicle in a manner not shown here in detail.

In the example shown here, the shaft 17 and the driver 18 are designed as hollow profiles in which a signal line 20 is routed to the outside in a protected manner from the angle measuring device 15.

The kingpin protrudes on the bottom side 19 with a projection 21 in the axial direction downwards over the driver 18 and the shaft 17 and thus serves to protect the shaft 17 and the driver 18 against collision with components of the tractor vehicle when entering or exiting the entry opening. The projection 21 is arranged on the front side of the kingpin 2 relative to the direction of travel 22 and spans a circular segment in the circumferential direction over an angle of approx. 100°. The kingpin is offset upwards by an angle of approx. 260° in order to allow a correspondingly large swivel range for the driver, which generally corresponds to the maximum articulation angle of the trailer relative to the tractor vehicle on both sides.

Viewed from above, the kingpin otherwise comprises, in a manner known per se, an upper collar 22, a constriction 23, and a lower collar 24. The constriction 23 is the section at which the locking device of the fifth wheel coupling engages. The upper collar 22, the constriction 23, and the lower collar 24 all have a circular cylindrical basic shape.

FIG. 2 shows a kingpin assembly 1′ that is largely identical in construction, the elements of which differ from those of the example according to FIG. 1 only in the following features.

In this example, the angle measuring device 15 is also recessed into the kingpin 2 on the upper side 13 to such an extent that the angle measuring device 15 has a distance d>1 mm, preferably >2 mm, from the base 16 of the weld-in plate 4, but here it does not close flush with the upper side 13, but protrudes slightly above it. If the installation space between the king pin flange 3 and the bottom 16 of the weld-in plate 7 allows, a shallower recess into the king pin is sufficient, thereby weakening the king pin less.

In this example, shaft 17 is designed as a hollow profile, but driver 18 is not. For this reason, the signal cable 20 is only protected within the shaft and leads out of the kingpin, but from there it runs along the outside of the driver 18. A solid driver has the advantage of greater strength, in particular greater bending stiffness, and can therefore transmit the same bending force with a smaller cross-section, which takes into account the limited installation space at this point.

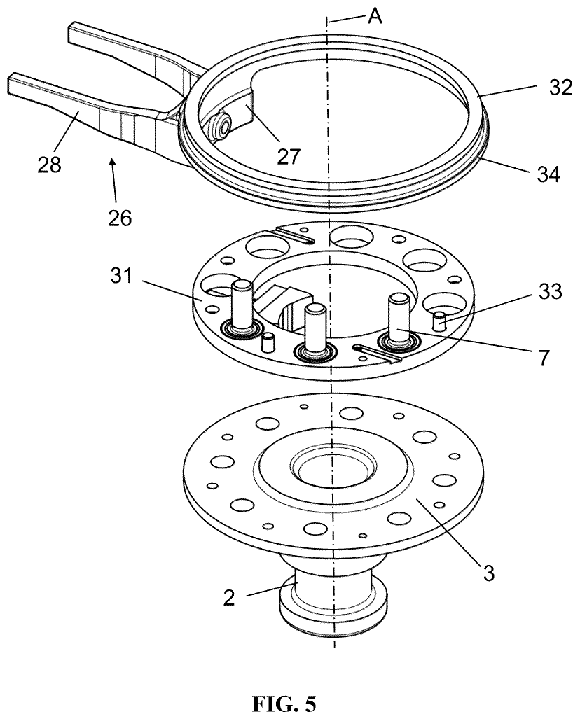

Another difference is that the kingpin assembly 1′ has a pivot bearing 25 arranged around the axis of rotation A and a support frame 26 connected to the pivot bearing 25 and pivotable around the axis of rotation A. The support frame 26 is shown again in full in the bottom view in FIG. 4, and the structure of the pivot bearing 25 is shown in detail in FIG. 5.

As shown in FIG. 4, the support frame 26 has a mounting base with a cylinder wall segment 27 and two retaining arms 28 extending in a fork-like manner essentially radially from the cylinder wall segment 27. The support frame 26 has a protective cover 29 on its upper side. Under the protective cover 29, inside the support frame 26 at its free end 30 and indirectly attached to it via a base plate, there is a connecting means, usually in the form of a plug (not shown). The support frame 26 is designed in sections as a V-shaped frame structure, the sides of which are adapted to the angle of the corresponding entry opening.

The weld-in plate 4 has an upward recess toward the floor 16, in which the kingpin flange 3 and parts of the pivot bearing 25 are received. The depth of the recess plus the thickness of the support plate 9 are dimensioned such that the pivot bearing 25 does not protrude beyond the bottom side of the support plate 9, with the exception of the molded cylinder wall segment 27 of the support frame 26.

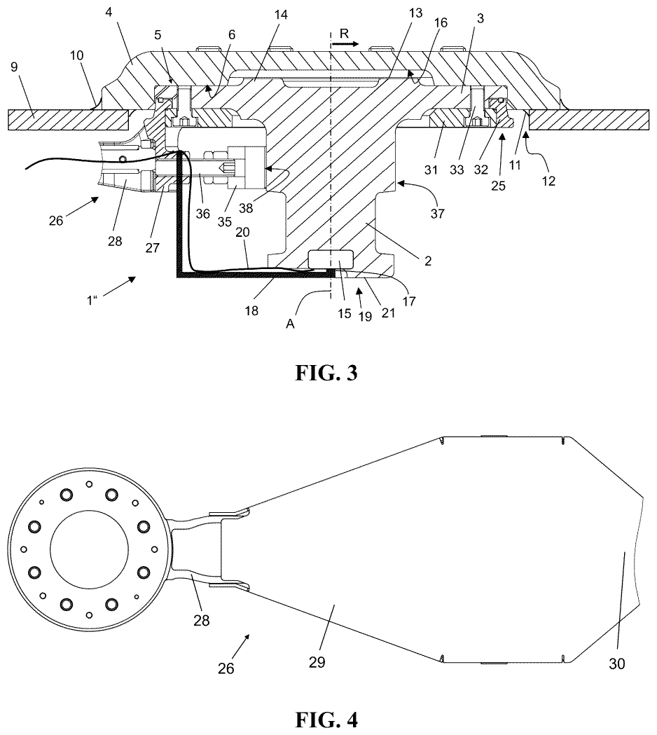

As shown in FIG. 5, the pivot bearing 25 comprises a bearing ring 31 fixed relative to the kingpin 2 and a bearing ring 32 rotatable relative thereto. The stationary bearing ring 31 is fastened directly to the kingpin flange 3 by means of screws 33., the kingpin assembly 1 as a whole or only parts of the pivot bearing 25 can be easily replaced by screwing the flange 3 to the weld-in plate 7 and screwing the stationary bearing ring 31 to the flange 3. In particular, no structural changes need to be made to the semi-trailer during retrofitting, because the kingpin assembly 1 according to the invention can simply be mounted in place of an old one. This is ensured not only by the identical screw connection, but also by the small installation space required for the pivot bearing 25 together with the support frame 26. For this purpose, it is advantageous if, as shown in FIGS. 2 and 3, the stationary bearing ring 31 is arranged radially inward relative to the axis of rotation A and the rotatable bearing ring 32 is arranged radially outward.

The rotatable bearing ring 32 together with the stationary bearing ring 31 forms an axial-radial-rotary bearing. In the axial direction, the bearing is achieved by the axial sliding surfaces of the bearing rings 31 and 32 resting on top of each other. The sliding surfaces define the “rotation plane.” In the radial direction, the bearing rings lie against each other along circular cylindrical surfaces and thusly restrict the degree of freedom of movement of the support frame 26 to a pure rotational movement. Along its outer circumferential surface, the rotatable bearing ring 32 has a circumferential stepped stiffening edge 34.

The support frame 26 is fixed to the rotatable bearing ring 31. In the embodiment shown, it is integrally molded to the latter with its cylinder wall segment 27. The cylinder wall segment 27 thus forms the vertical connection from the plane of rotation to the support frame 4, see FIGS. 2 and 3. The position of the support frame 26 is thus determined by the pivot bearing 25 radially and axially relative to the kingpin 2 and the support plate 9.

To inhibit the support frame 26 from tilting downwards due to its radial length, the kingpin assembly 1 has a support element 35. This is connected to the support frame 26 by means of a connecting element 36 that is longitudinally adjustable in the radial direction R relative to the axis of rotation A. It is arranged axially spaced below the plane of rotation and is supported there directly on a circumferential or cylindrical shell surface 37 of the upper collar 22 of the kingpin 2, which is arranged coaxially around the axis of rotation A. While the constriction 23 must remain completely free for locking with the fifth wheel coupling, in an alternative design, the support element 35 can also be supported on the lower collar 24, thereby providing a larger overall lever and thus a firmer support.

In this example, the connecting element 36 is designed as a threaded rod that is screwed into the cylinder wall segment 27 on the radially outer side and is thus supported by it. Alternatively, it can also be fixed to it by means of a material-locking or force-fitting connection, for example. On the other side, the threaded rod is screwed into a metal block of the support element 35 and secured with a nut. As part of the support element 35, the threaded rod ensures that it can be adjusted in the radial direction R. If the support element 35 is extended, for example in the radial direction, by unscrewing the threaded rod, the support frame 26 is raised at its free end 30, where the connecting means or plug (not shown) is located, and vice versa, it is lowered by screwing it in. The support frame 26 can thus be adjusted precisely, for example, to the degree of wear of the kingpin, structural tolerances of the support frame, plug, or support plate, so that the plug can be brought exactly into its intended position vertically.

The support element 35 also has a sliding surface 38 that is in direct contact with the cylinder surface of the kingpin 2, which is formed on a plastic block that is in turn glued or otherwise attached to the metal block of the support element 35. The plastic block ( ) has a plastic matrix in which tribologically effective filler particles can be dispersed in order to reduce the coefficient of friction in interaction with the surface of the kingpin (2).

The sliding surface 38 is designed as a concave curved surface with a radius r, whereby the support element 35 aligns itself relative to the kingpin 2 in a tangential direction with respect to the axis of rotation A or the cylinder surface 37 of the kingpin 2.

In this embodiment, the driver 18 is fixed to the support frame 26 and, more precisely, to the cylinder wall segment 27. Since the cylinder wall segment 27 is integrally formed on the rotatable bearing ring 32, the driver 18 is thus also fixed directly to the rotatable bearing ring 32. In this way, the driver 18 is held at its end facing away from the shaft 17 and guided in a precise circular path around the axis of rotation A. This supports the radial bearing of the shaft 17 in the angle measuring device 15 and in the bore of the kingpin 2.

In this example, the angle measurement signal from the angle measuring device 15 is routed via the signal line 20 from the end of the driver 18 in a radial direction to the plug (not shown) and can be transferred via this to a coupled tractor vehicle. However, the signal line 20 can also or additionally lead directly within the semi-trailer to a processor which processes the signal, for example for the purpose of controlling steerable axles or driving assistance systems.

The kingpin assembly 1″ of the embodiment shown in FIG. 3 has essentially the same structural design as that of the embodiment shown in FIG. 2. The differences lie in the positioning of the angle measuring device 15, which is recessed into the kingpin 2 on the bottom side 19 facing away from the kingpin flange. As a result, the axial bore through the kingpin is omitted and the shaft 17 is significantly shorter. Otherwise, the driver 18 is also connected to the shaft 17 and runs in the same way as in the embodiment shown in FIG. 2 until its end fixed to the cylinder wall segment 27. In this arrangement, the guidance of the driver 18 at its end facing away from the shaft 17 is even more important because the comparatively short shaft 17 is only mounted or supported in the angle measuring device 15 and no longer additionally in a bore in the king pin 2. The signal line 20 runs completely outside the shaft 17 and along the driver 18.

### LIST OF REFERENCE SIGNS

1, 1′, 1″ Kingpin assembly
2 Kingpin
3 Kingpin flange
4 Weld-in plate
5 Mounting surface of the kingpin flange
6 Mounting surface of the weld-in plate
7 Screw
9 Support plate
10 First weld seam
11 Second weld seam
12 Through hole
13 Upper side of the kingpin
14 Bead
15 Angle measuring device
16 Bottom of the weld-in plate
17 Shaft
18 Driver
19 Bottom side of the kingpin
20 Signal line
21 Protrusion
22 Upper collar
23 Constriction
24 Lower collar
25 Pivot bearing
26 Support frame
27 Cylinder wall segment
28 Retaining arm
29 Protective cover
30 Free end (of the support frame)
31 Stationary bearing ring
32 Rotatable bearing ring
33 Screw
34 Stiffening rim
35 Support element
36 Connecting element
37 Cylinder shell surface
38 Sliding surface
A Axis of rotation
d Distance
r Radius
R Radial direction

1. A kingpin assembly (1) for a semi-trailer of an articulated vehicle, comprising
a kingpin (2) defining an axis of rotation (A), wherein the kingpin (2) has a kingpin flange (3) for connecting the kingpin (2) directly or indirectly to the semi-trailer,
characterized by an angle measuring device (15) at least partially recessed into the kingpin (2) with a shaft (17) rotatably mounted about an axis of rotation (A) and by a driver (18) connected to the shaft (17) and pivotable about the axis of rotation (A).

2. The kingpin assembly (1) according to claim 1,
characterized in that the shaft (17) is led out on a bottom side (19) of the king pin (2) facing away from the king pin flange (3) and is connected to the driver (18).

3. The kingpin assembly (1) according to claim 1,
characterized in that the king pin (2) protrudes on a bottom side (19) facing away from the king pin flange (3) with at least one projection (21) in an axial direction (R) downwards beyond the driver (18) and the shaft (17).

4. The kingpin assembly (1) according to claim 1,
characterized in that the driver (18) comprises a centering element that is arranged to center the driver (18) with respect to an entry opening of a fifth wheel coupling plate of a tractor vehicle.

5. The kingpin assembly (1) according to claim 1, characterized in that the angle measuring device (15) comprises a magnetic angle sensor and an angle encoder generating a magnetization pattern.

6. The kingpin assembly (1) according to claim 5,
characterized in that the magnetization pattern defines a center position.

7. The kingpin assembly (1) according to claim 1,
characterized by a weld-in plate (7) connected or connectable to the semi-trailer, which is designed for connection to the kingpin flange (3).

8. The kingpin assembly (1) according to claim 1,
characterized in that the angle measuring device (15) is recessed into the kingpin (2) on an upper side (13) attributed to the kingpin flange (3) and in that the shaft (17) is rotatably mounted or received in a bore axially penetrating the kingpin (2).

9. The kingpin assembly (1) according to claim 7,
characterized in that the angle measuring device (15) is recessed on the-an upper side (13) into the kingpin (2) to such an extent that the angle measuring device (15) has a distance d>1 mm from a bottom (16) of the weld-in plate (7) when the kingpin (2) is connected to the weld-in plate (7).

10. The kingpin assembly (1) according to claim 9,
characterized in that the angle measuring device (15) is recessed flush with the upper side (13) in the kingpin (2).

11. The kingpin assembly (1) according to claim 1,
characterized in that the angle measuring device (15) is recessed into the kingpin (2) on a bottom side (19) facing away from the kingpin flange (3).

12. The kingpin assembly (1) according to claim 1,
characterized by a pivot bearing (25) arranged about the axis of rotation (A), which has a bearing ring (31) stationary relative to the kingpin (2) or a stationary bearing ring segment and a bearing ring (32) rotatable relative thereto or a rotatable bearing ring segment, wherein the driver (18) is fixed directly or indirectly to the rotatable bearing ring (32) or rotatable bearing ring segment.

13. The kingpin assembly (1) according to claim 12,
characterized by a support frame (26) fixed to the rotatable bearing ring (32) or rotatable bearing ring segment, wherein the driver (18) is fixed to the support frame (26).

14. The kingpin assembly (1) according to claim 13, characterized in that the support frame (26) is configured to accommodate a connecting means for connection to a corresponding connecting unit of a tractor vehicle, in particular an electrical and/or electromagnetic and/or pneumatic and/or hydraulic connecting means.

15. The kingpin assembly (1) according to claim 13,
characterized in that the support frame (26) has a support element (35) that is axially spaced from the rotatable bearing ring (32) or the rotatable bearing ring segment and rests directly against the kingpin (2).
